(19) United States
(12) Patent Application Publication
(10) Pub. No.: US 2005/0124281 A1
(43) Pub. Date: Jun. 9, 2005

(54) Coin pusher mechanisms comprising an array of pushers

(76) Inventors: Barry Marchini, Bridgend (GB); Dimitri Malkin, Bridgend (GB)

Correspondence Address: YOUNG & THOMPSON, 745 SOUTH 23RD STREET, 2ND FLOOR, ARLINGTON, VA, 22202, US

(21) Appl. No.: 10/496,375

(22) PCT Filed: Nov. 22, 2002
(86) PCT No.: PCT/GB02/05400

(30) Foreign Application Priority Data
Nov. 24, 2001 (GB) 0128251.6

(51) Int. Cl. G07D 1/00

(52) U.S. Cl. 453/18

(57) ABSTRACT

An amusement machine pusher mechanism as shown in FIG. 2, comprises a series of pushers (10), arranged side-by-side. The pushers are each associated , with a respective gear (15) having an upstanding off-centre pin (15) which engages with a transverse tract across the underside of an associated pusher. A motor (13) is mounted beneath a surface on which the pushers/gears are mounted and the motor drives one gear (15). As the gear (15) rotates, the other tears in the gear train are caused to rotate with the result that each of the pushers is moved hack and forth across the surface.

This invention relates to coin pusher mechanisms for amusement machines in which pieces, such as coins, are haphazardly strewn on a surface and a pusher mechanism nudges the pieces towards an edge. Occasionally, a piece is pushed off, and that is won by the player.

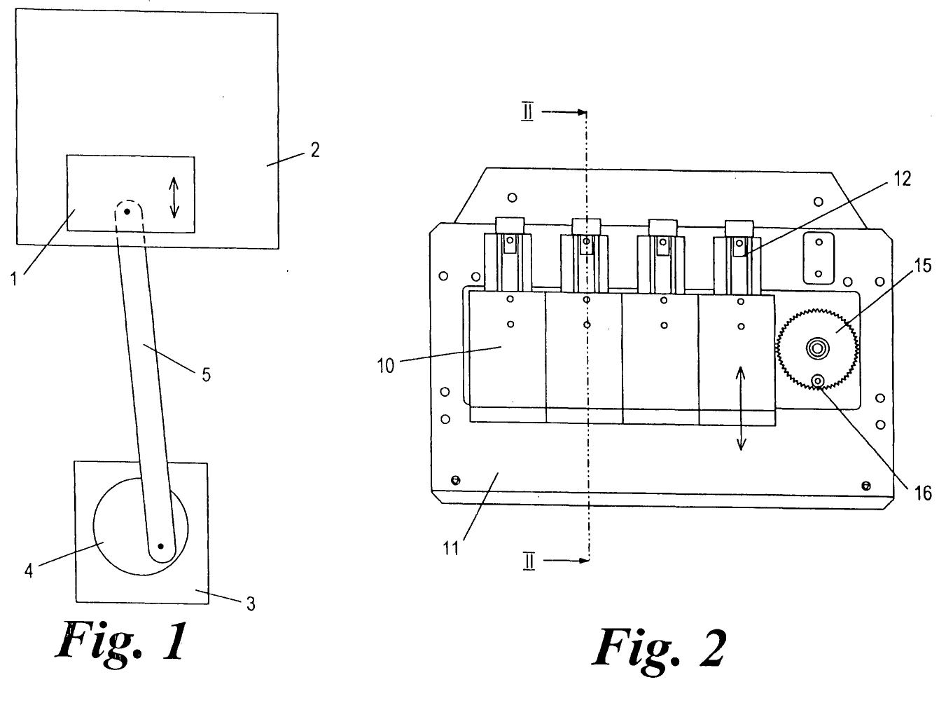

Conventionally, the pusher mechanism is of the kind diagrammatically illustrated in FIG. 1 of the accompanying drawing. A platen 1 is moved back and forth in the direction of the arrows over a portion of a table 2 on which coins are scattered. The movement is generated by crank action, a motor 3 continuously rotating a disc 4 with an eccentric pin by which an arm 5 coupled to the platen 1 is reciprocated. This arrangement is prone to wear, it is bulky, and it requires a deep cabinet for the drive unit.

According to the present invention there is provided a pusher mechanism for an amusement machine in which pieces are haphazardly strewn on a surface and a reciprocating pusher device nudges the pieces towards and occasionally over an edge of the surface, those being pushed off being won by the player, wherein the mechanism comprises an array of side-by-side pushers with each of the pushers being crank-coupled to an associated rotary member, whereby rotation of a rotary member causes reciprocation of the associated pusher in a direction transverse to the array, with the rotary members being coupled so that rotation of one rotary member generates rotation of all.

Conveniently, the rotary members are meshing gearwheels. Preferably, they will mesh directly, but they could be coupled by intermediate gears. Alternative arrangements include sprockets and chains, or simply friction engagement between adjacent discs.

Generally, the gearwheels will be of the same size and the cranks will have the same throw. But it is quite possible, if desired, to have differences along the array of pushers, so that some will not move as much as others, and/or some will move more rapidly than others.

Preferably, the cranks will be arranged so that the pushers are out of phase, creating a ripple effect as they move back and forth.

The crank coupling is conveniently an off-centre pin on each rotary member engaged with a transverse guide on the underside of the associated pusher.

For a better understanding of the invention, one embodiment will now be described, by way of example, with reference to the remaining figures of the accompanying drawing, in which:

FIG. 2 is a plan view of a pusher mechanism with one pusher removed,

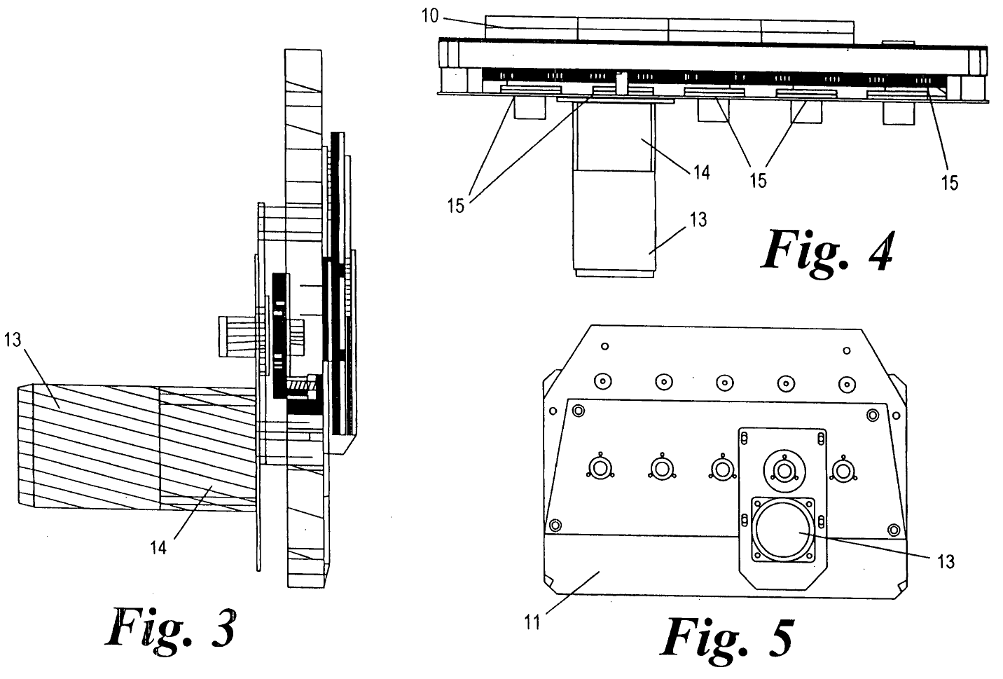

FIG. 3 is a section on the line II-II of FIG. 2,

FIG. 4 is a front elevation of the pusher mechanism, and

FIG. 5 is an underneath plan view of the pusher mechanism,

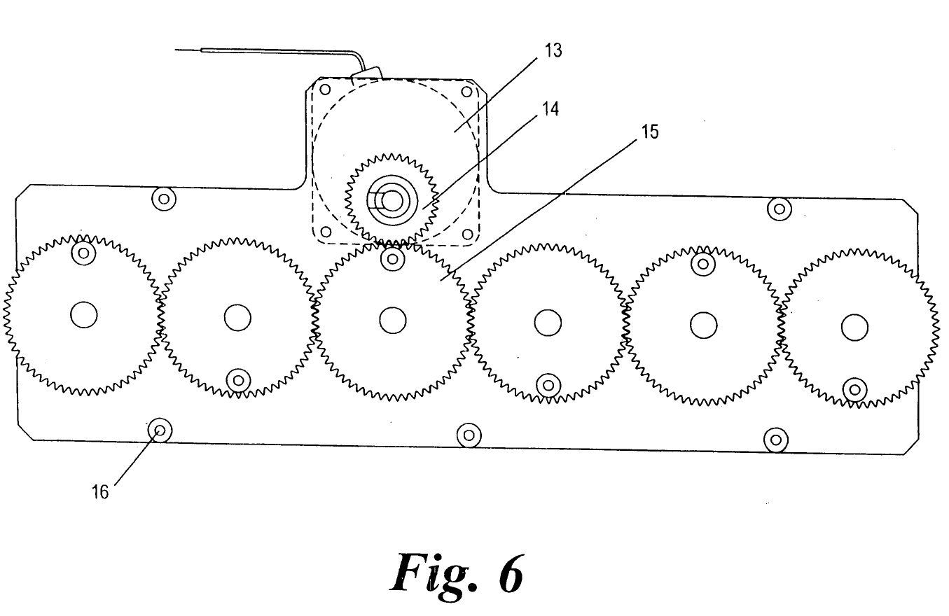

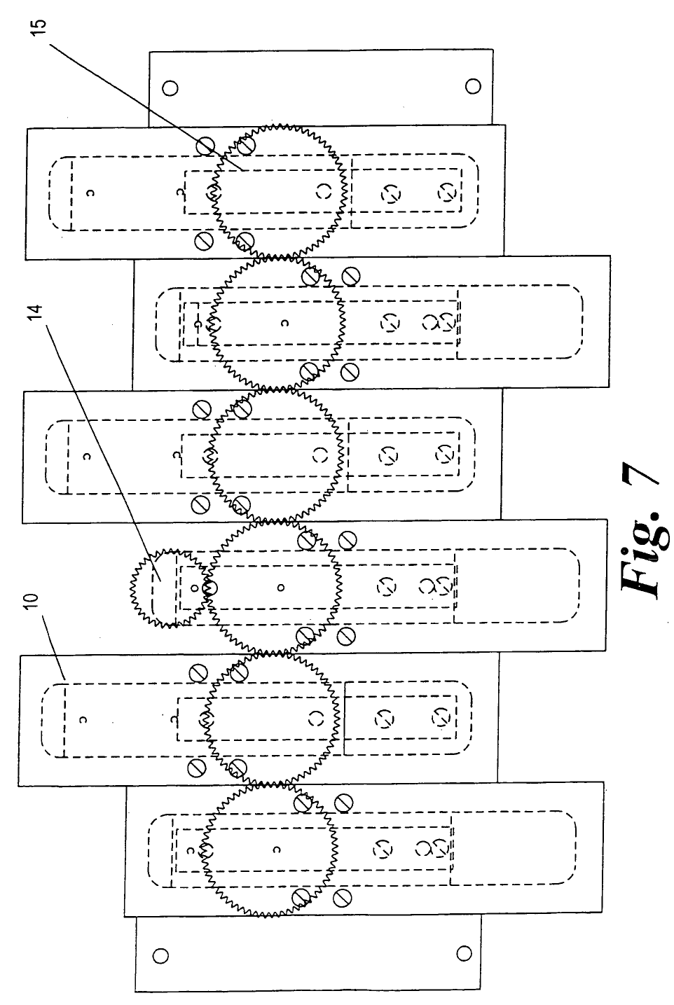

FIG. 6 shows an alternative arrangement of linear gears,

FIG. 7 shows a linear arrangement of gears, with pushers located in varying positions to create a ripple effect.

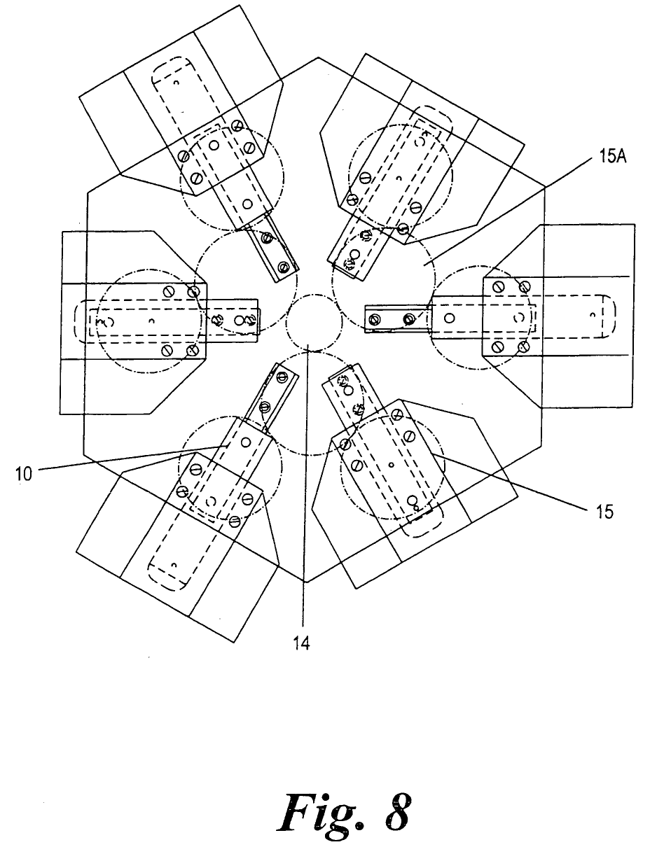

FIG. 8 shows a plan view of a circular arrangement of pushers, and

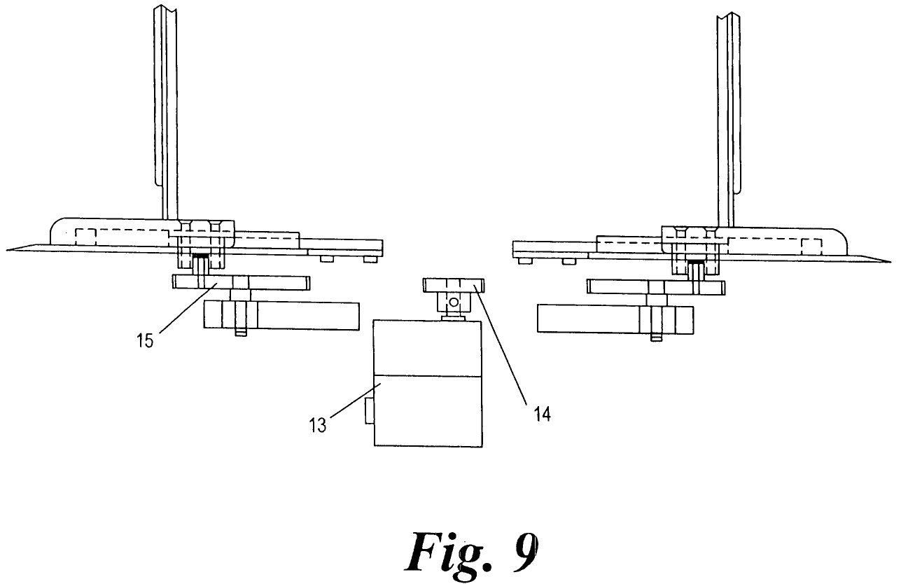

FIG. 9 shows a side view of the arrangement shown in FIG. 8.

In the example of FIGS. 2 to 5, there are five pushers 10, one not being shown, each in the form of a rectangular platen and being arranged in a side-by-side array. They will move horizontally, transverse to that array, back and forth over a surface such as a table or mounting plate 11, as indicated by the double arrow, being guided by sliders 12. A motor 13 mounted vertically beneath the table drives, through a reduction gear box 14, a gear 15 whose diameter is equal to the width of the pusher 10 above and whose centre registers with the longitudinal centre line of that pusher. There are similar gears correspondingly disposed under the other pushers and they mesh in a linear gear train. Each gear 15 has an upstanding off-centre pin 16 which engages with a transverse track across the underside of the associated pusher 10.

It will be appreciated that the motor 13 rotating one gear 15 will cause all the gears to rotate, adjacent ones in different directions, and that by their crank coupling to the pushers 10 the latter will be moved back and forth.

Preferably the pins 16 will not be arranged so that the pushers 10 will all move in unison as a single platen. They may be angularly offset with respect to each other at a datum position by 72° along the array. This means that while some pushers 10 are moving forwards, others are going backwards, or a combination of such movements is made, resulting in a ripple effect being observed at their leading edges which co-operate with the pieces. Although preferably the pieces used with the amusement apparatus are coins so that the person playing the machine can receive their prize as a result of pieces being pushed off the table, as a monetary payout, it is envisaged that the pieces may be tokens. If tokens are paid out, these can either be exchanged for cash or fed back into the amusement machine so further games can be played on the amusement apparatus.

As shown in FIG. 6, the position of the motor 13 can be positioned to co-operate with any of the gears 15. Therefore, although in FIG. 5 the motor is shown as co-operating with a gear one in from the row of gears 15, as shown in FIG. 6, where there is an array of six gears, the gearbox can co-operate with one of the more central gears.

FIG. 5 shows a plan view of the arrangement as shown in FIG. 6 with the pushers 10 in position. Intermediate gear 14 drives gears 15 and in this arrangement the pushers are shown in staggered arrangement so that a ripple effect can be produced by the pushers.

In FIG. 8, there is shown a circular arrangement of pushers 10, each being driven by a gear 15 which co-operates with a central gear 14 driven by a motor. The link between gears 15 and central gear 14 is provided by intermediate gears 15A. FIG. 9 shows a side view of the arrangement of FIG. 8, with motor 13 and its associated gearbox 14 that co-operates with gears 15 via intermediate gears (not shown). Again, although six pushers are shown in this arrangement, it is envisaged that any number of pushers may be provided. Further, although the motor preferably is beneath the table on which the playing pieces are strewn, it is envisaged that the motor and associated gearbox, together with the gears, may be positioned above the pushers so that pieces can be pushed from above, and this is more applicable to arrangements where pieces are being pushed into apertures in a playing surface rather than where pieces are being pushed off the side of a table surface. Adaptations of the equipment can be made to hide the motors so that the device is more aesthetically acceptable.

1. A pusher mechanism for an amusement machine in which pieces are haphazardly strewn on a surface and a reciprocating pusher device nudges the pieces towards and occasionally over an edge of the surface, those being pushed off being won by the player, wherein the mechanism comprises an array of side-by-side pushers with a crank coupling between each pusher and a rotary member associated with each pusher, whereby rotation of that member causing reciprocation of the associated pusher in a direction transverse to the array, with the rotary members being coupled so that rotation of one generates rotation of all.

2. A pusher mechanism according to claim 1, wherein the pushers are in a substantially linear side-by-side arrangement.

3. A pusher mechanism according to claim 1, wherein the pushers are in a substantially circular or arc arrangement.

4. A pusher mechanism according to claim 3, wherein the edge of the table forms an aperture with the substantially circular or arc arrangement of pushers being positioned in proximity to the perimeter of said aperture, whereby movement of the pushers causes pieces to be pushed off the edge of the surface into said aperture.

5. A pusher mechanism according to claim 1, wherein the rotary member is below said pusher.

6. A pusher mechanism according to claim 1, wherein the rotary member is above the said pusher.

7. A pusher mechanism according to claim 1, wherein the rotary members are meshing gearwheels.

8. A pusher mechanism according to claim 1, wherein the rotary members are coupled by intermediate gears.

9. A pusher mechanism according to claim 1, wherein the gearwheels are of varying sizes within the array of pushers, thereby creating varying degrees of movement of the pushers.

10. A pusher mechanism according to claim 1, wherein the cranks are arranged so that the pushers move out of phase so creating a ripple effect as they move back and forth.

11. A pusher mechanism according to claim 1, wherein the crank coupling is an off-centre pin projecting from each rotary member, said pin engaging a guide on the underside of a pusher associated with said rotary member.

12. A pusher mechanism according to claim 1, wherein the pieces are coins or tokens.
